(19) United States
(12) Patent Application Publication
(10) Pub. No.: US 2026/0203642 A1
(43) Pub. Date: Jul. 16, 2026

(54) DATA GENERATION WITH MULTIPLE CUSTOMIZED GENERATIVE MACHINE LEARNING MODELS

(71) Applicant: GDM Holding LLC, Mountain View, CA (US)

(72) Inventors: Matthew Sharifi, Kilchberg (CH); Florian Nils Hartmann, Zurich (CH)

(21) Appl. No.: 19/019,173

(22) Filed: Jan. 13, 2025

(51) Int. Cl. G06N 20/00

(52) U.S. Cl. CPC G06N 20/00

(57) ABSTRACT

This specification describes a method performed by one or more data processing apparatus. The method comprises obtaining a user query and obtaining a set of candidate models comprising a plurality of customized generative machine learning models. The method further comprises pruning the set of candidate models. Pruning the set of candidate models comprises processing the user query using each model of the set of candidate models to generate an intermediate output for each model, generating a score for each model in the set of candidate models by evaluating the intermediate output for each model using a critic machine learning model and pruning the set of candidate models based upon the generated scores for each model. The method further comprises continuing processing of the user query using the set of remaining candidate models to generate an output in response to the user query.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers to generate an output for a received input. For example, a deep neural network is a deep machine learning model that includes an output layer and one or more hidden layers that each apply a non-linear transformation to a received input to generate an output.

### SUMMARY

According to a first aspect, there is provided a method performed by one or more data processing apparatus. The method comprises obtaining a user query and obtaining a set of candidate models comprising a plurality of customized generative machine learning models. The method further comprises pruning the set of candidate models. Pruning the set of candidate models comprises processing the user query using each model of the set of candidate models to generate an intermediate output for each model, generating a score for each model in the set of candidate models by evaluating the intermediate output for each model using a critic machine learning model, and pruning the set of candidate models based upon the generated scores for each model. The method further comprises continuing processing of the user query using the set of remaining candidate models to generate an output in response to the user query.

In some implementations, the plurality of customized generative machine learning models utilize the same underlying generative machine learning model and are customized using different system prompts and/or contextual data. In some implementations, at least two of the customized generative machine learning models are different. For example, the parameter values and/or architectures of the models are different.

In some implementations, each system prompt comprises one or more instructions for generating output by the generative machine learning model.

In some implementations, the contextual data comprises data retrieved from one or more external data sources. For example, the contextual data can be retrieved based upon a retrieval augmented generation (RAG) technique.

In some implementations, processing the user query using each model of the set of candidate models to generate an intermediate output for each model comprises generating, for each model, a model input based upon the user query and the system prompt and/or contextual data used to customize the model, collecting a plurality of respective model inputs to form a batch input, and processing the batch input using the same underlying generative machine learning model to generate the intermediate output for the models corresponding to the collected plurality of respective model inputs.

In some implementations, processing the user query using each model of the set of candidate models to generate an intermediate output for each model comprises processing the user query using each model for a pre-determined number of generation steps to generate the intermediate output.

In some implementations, pruning the set of candidate models based upon the generated scores for each model comprises removing up to and including half of the models in the set of candidate models.

In some implementations, continuing processing of the user query using the set of remaining candidate models to generate an output in response to the user query comprises repeatedly pruning the set of remaining candidate models based upon subsequent intermediate outputs generated from the continued processing of the user query by the remaining candidate models.

In some implementations, the repeated pruning is carried out according to a pruning schedule. For example, the pruning schedule can be based upon a pre-determined number of generation steps to run each model for in order to generate the subsequent intermediate outputs.

In some implementations, the intermediate output for a model comprises an indicator that the model cannot satisfy the user query and in response to detecting the indicator, the method further comprises pruning the model from the set of candidate models.

In some implementations, pruning the set of candidate models is further based upon user feedback obtained on the generated intermediate outputs. In some implementations, the method further comprises updating the critic machine learning model based upon the user feedback.

In some implementations, generating an output in response to the user query comprises obtaining a final output from each candidate model in the set of remaining candidate models, evaluating the final output using the critic machine learning model to generate a final score for each candidate model, and providing as the output in response to the user query, at least the highest scoring final output.

In some implementations, the method further comprises additionally providing the final output of one or more other candidate models, receiving an indication that a user selected a non-highest scoring final output, and updating the critic machine learning model based upon the non-highest scoring final output selected by the user.

In some implementations, the method further comprises additionally providing the intermediate output of a pruned candidate model, receiving an indication that a user selected the intermediate output of the pruned candidate model, resuming processing of the user query using the pruned candidate model from its intermediate output to generate a response to the user query, and updating the critic machine learning model based upon the pruned candidate model selected by the user. In some implementations, updating the critic machine learning model based upon the pruned candidate model selected by the user comprises updating the critic machine learning model based upon the intermediate output of the pruned candidate model and/or the response generated by the pruned candidate model.

In some implementations, the set of candidate models are obtained based upon determining an available customized model's relevance to the user query.

In some implementations, the set of candidate models are obtained based upon a measure of diversity of an available set of customized models.

In some implementations, the generative machine learning model is a large language model (LLM) based machine learning model (e.g. foundation model). This can also include multi-modal models that are capable of processing text input together with other modalities such as image, video and/or audio.

According to a second aspect, there is provided a system comprising one or more data processing apparatus and a memory. The memory stores instructions that when executed by the one or more data processing apparatus, causes the one or more data processing apparatus to carry out a method according to the first aspect.

According to a third aspect, there is provided a non-transitory computer-readable storage medium comprising instructions that when executed by one or more data processing apparatus cause the one or more data processing apparatus to carry out a method according to the first aspect.

According to a fourth aspect, there is provided a system comprising one or more data processing apparatus and a memory. The memory stores instructions that when executed by the one or more data processing apparatus, causes the one or more data processing apparatus to carry out a method comprising obtaining a user query and obtaining a set of candidate prompts, wherein each candidate prompt comprises a different set of instructions for generating output by a generative machine learning model in response to user queries. For each respective candidate prompt of the set of candidate prompts: processing the user query and the respective candidate prompt using the generative machine learning model to generate a partial output in response to the user query, and generating a score for the respective candidate prompt by evaluating the partial output using a critic machine learning model. The method further comprises pruning the set of candidate prompts based upon the scores for each candidate prompt and for each remaining candidate prompt in the set of candidate prompts, resuming processing of the user query and the respective candidate prompt by the generative machine learning model from the corresponding partial output.

According to a fifth aspect, there is provided a non-transitory computer-readable storage medium comprising instructions that when executed by one or more data processing apparatus cause the one or more data processing apparatus to carry out a method comprising obtaining a user query and obtaining candidate contextual data, wherein the candidate contextual data is divided into a plurality of candidate chunks, and wherein the candidate contextual data is obtained from one or more data sources based upon the user query. For each respective candidate chunk: processing the user query and the respective candidate chunk using the generative machine learning model to generate a partial output in response to the user query, and generating a score for each candidate chunk by evaluating the partial output using a critic machine learning model. The method further comprises pruning the plurality of candidate chunks based upon the scores for each candidate chunk, and generating an output in response to the user query using the generative machine learning model based upon the remaining candidate chunks.

It will be appreciated that features described in the context of one aspect may be combined with features of one or more other aspects.

Particular embodiments of the subject matter described in this specification can be implemented so as to realize one or more of the following advantages.

A user may have access to a plurality of customized generative machine learning models. In some cases, the user may not know which model is best for responding to a particular query. In other cases, it is desirable to minimize the amount of user interaction necessary to generate responses to user queries. The techniques described herein provide for efficient generation of responses to user queries using the most appropriate customized model automatically.

The techniques described herein can iteratively prune a set of candidate customized generative machine learning models in generating a response to the user query. The techniques described herein enable the evaluation of the full range of customized models whilst the systematic elimination of the least promising models early ensures that the overall data generation process is still computationally efficient. By using a fixed pruning schedule, the total number of generation steps carried out by the eliminated models can be kept bounded. In some implementations, half of the candidate models are removed in each pruning round, providing for O(log n) complexity.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic block diagram illustrating an example of a data generation system.

FIG. 2 is a schematic illustration of an iterative pruning process according to an implementation.

FIG. 3 is a flowchart illustrating an example method for generating output in response to a user query according to an implementation.

FIG. 4 is a flowchart illustrating another example method for generating output in response to a user query according to an implementation.

FIG. 5 is a flowchart illustrating a further example method for generating output in response to a user query according to an implementation.

Like reference numbers and designations in the various drawings indicate like elements.

### DETAILED DESCRIPTION

Generative machine learning models have been used to generate data of many different modalities including text data, image data, video data and audio data. Generative machine learning models may include foundation models and large language model (LLM) type machine learning models and their multi-modal equivalents. Typically, these models generate output in response to a prompt that comprises instructions in natural language specifying what is to be generated. Such models can also function as AI assistants to assist users in carrying out a variety of tasks and the user prompt can specify the task to be performed by the generative machine learning model.

Typically, generative machine learning models are trained on large scale diverse datasets to enable general purpose capability. Generative machine learning models can then be customized to perform more specific tasks in a variety of ways. For example, a generative machine learning model can undergo further training, such as supervised fine-tuning, using a smaller-scale, high quality dataset representative of the desired specialized task. In another example, the generative machine learning model can retrieve contextual data from one or more data sources and generate output based upon the retrieved contextual data. This allows the generative machine learning model to carry out generation based upon the data from the one or more data sources specifically. In a further example, a prompt comprising specific customized instructions for influencing or constraining the generation behavior of the generative machine learning model can be used. In this latter case, these prompts will be referred to as system prompts.

System prompts provide an easy way for customizing a generative machine learning model and can be devised by users themselves (or other entities). Users can share their system prompts via online platforms. It is possible for a user to obtain many different customized models via different system prompts. These can be customized versions of a particular task. For example, an image generation model can be customized to produce images having a certain style, e.g. photorealistic, cartoon, painting. The system prompts can further provide more specific instructions, e.g. for photorealistic image generation, the system prompts can specify specific lighting conditions, camera settings, framing and compositionality. In another example, a text generation machine learning model can be customized to act as a coding assistant and be further customized by programming language or programming style, e.g. to emphasize readability of code, or to optimize for CPU usage, or to optimize for memory usage. In a further example, a text generation machine learning model can be customized to act as a booking agent and be further customized based upon domain, e.g. restaurants, flights, hotels.

Regardless of the method of customization, a user can have multiple different customized models available from which to generate output in response to a user query. In some cases, the user may not know which model is best for responding to the query, particularly where the models relate to the same overall task. In other cases, it is desired to minimize the number of user interactions necessary to generate a response to the user query. Thus, it may be desired for a user to be able to input a query into a system and to automatically have the most appropriate model generate a response to the query without the user having to specifically select the model.

In some prior art techniques, a classifier known as a query router can be used to classify an input query and route it to the most appropriate model. However, given the range of customizations that are possible, particularly with the open-endedness of system prompts, it can be difficult to train a classifier that can accurately predict the relevance of a customized model to a user query.

The techniques described herein enable the efficient generation of an output in response to a user query using the most relevant model automatically. The techniques described herein utilizes an iterative pruning of a set of candidate customized generative machine learning models for responding to the user query. In particular, processing of the user query by each candidate model is initiated. After N generation steps have occurred (or using any other suitable stopping criteria), the output that has been generated so far can be evaluated by a critic machine learning model. The candidate models that have generated output that are deemed the least relevant in responding to the user query can be pruned (removed) from the set of candidate models. For example, in some implementations, half of the candidate models are pruned away. The remaining candidate models can continue processing of the user query and further pruning iterations can be carried out to remove and terminate the processing of the least promising candidate models. This process can continue until one candidate model remains (or a desired number of candidate models remain). In some instances, the generation process can complete before the pruning process fully completes. Should there be more than one candidate model remaining, the critic machine learning model can perform a final evaluation to determine which output is provided to the user in response to the user query. In this way, the user is provided with an output response from the most relevant customized model available without the user needing to select a particular customized model. The method can minimize the amount of user interaction necessary to generate a response where there are multiple customized models available. Put another way, the user can benefit from having additional customized models without any increase in user interaction required during the inference process.

The techniques described herein enable the evaluation of the full range of customized models whilst the systematic elimination of the least promising models early ensures that the overall data generation process is still computationally efficient. By using a fixed pruning schedule, the total number of generation steps carried out by the eliminated models can be kept bounded.

In implementations where the customization is achieved using different system prompts or contextual data that is processed by the same underlying generative machine learning model, batch processing can be used to perform the generation process according to the different system prompts/contextual data in parallel. This can leverage the parallel processing capabilities of accelerator hardware such as graphics processing units (GPUs) and tensor processing units (TPUs) for greater efficiency.

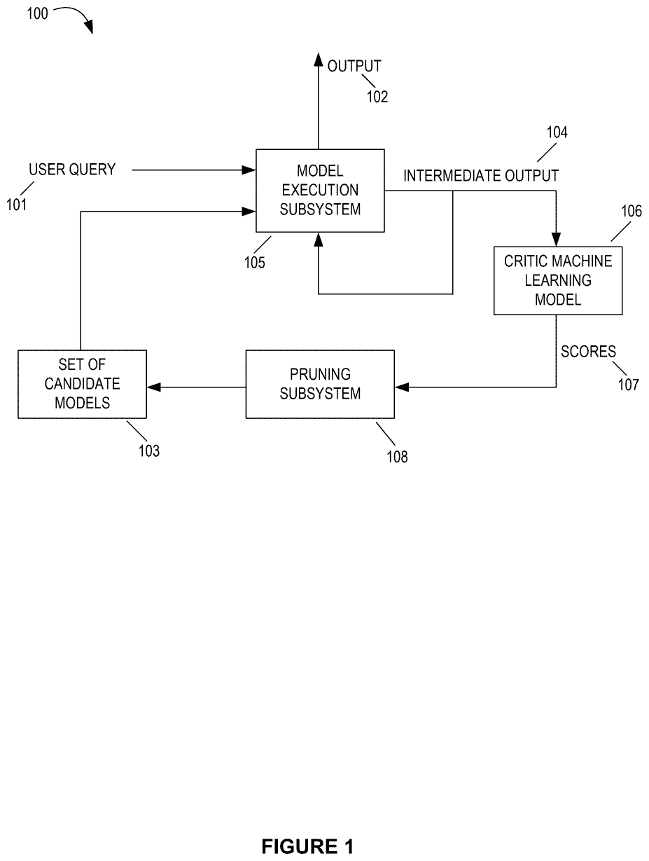

Referring now to FIG. 1, a data generation system 100 is shown. The data generation system 100 can be implemented using one or more data processing apparatus in one or more locations. The data processing apparatus can include any appropriate hardware such as a personal computer, a server, a laptop, a mobile device or more specifically any type of processing unit such as a CPU, GPU, TPU or specialized hardware apparatus such as an FPGA or ASIC.

The data generation system 100 is configured to obtain a user query 101. The user query 101 can be transmitted to the data generation system 100 using any suitable network connection from a user device or the data generation system 100 can comprise a user interface for users to interact with the data generation system 100.

The user query 101 can comprise instructions for generating data or specify a particular task for the data generation system 100 to perform. The user query 101 can also be referred to as a user prompt. The data generation system 100 is configured to generate output 102 in response to the user query 101. For example, the user query 101 can comprise text in natural language instructing the generation of a particular modality (or modalities) of data and describing the data to be generated. In some implementations, the user query 101 can comprise additional data such as image, video and/or audio data in which generation can be conditioned on.

The data generation system 100 is further configured to obtain a set of candidate models 103. The set of candidate models 103 comprises a plurality of customized generative machine learning models. As discussed above, customization of a generative machine learning model can be achieved in a variety of ways. For example, the plurality of customized generative machine learning model models can utilize the same underlying generative machine learning model be customized using different system prompts. That is, the different system prompts provide different sets of instructions that specifies the generation behavior of the generative machine learning model. Thus, a system prompt comprises one or more instructions for generating output by the generative machine learning model.

In another example, the plurality of customized generative machine learning models can utilize the same underlying generative machine learning model and be customized using different contextual data. The contextual data can be retrieved from one or more data sources which can be external to the data processing system 100. The contextual data can be retrieved based upon a retrieval augmented generation (RAG) technique. For example, a similarity measure can be used to identify chunks of data that appear to be the most relevant to the user query 101 from the one or more data sources. Each chunk individually and/or different combinations of chunks can form contextual data for customizing the generative machine learning model.

The examples above provide customization of a generative machine learning model without needing to alter the model. In other implementations, some or all of the generative machine learning models can be different, e.g. the generative machine learning models can have different parameter values achieved through training using different parameter initializations or hyperparameters, training using different training datasets or dataset splits, training using different objective functions, have different architectures or using any other suitable technique of achieving model variation. It will be appreciated that the plurality of customized generative machine learning models can include any combination of models customized in any appropriate way.

The set of candidate models 103 can be obtained by any appropriate means. For example, as described above, users (or other entities) can devise custom system prompts and these can be shared with other users via various platforms online. Additionally or alternatively, (different) customized generative machine learning models can be downloaded from various online repositories. In some implementations, the customized generative machine learning models are associated with a user account and the set of candidate models 103 can be selected from the models that are available to the user account. In some implementations, all of the models associated with the user account can constitute the set of candidate models 103. Alternatively, a subset of the models available to the user account is selected to form the set of candidate models 103. In other implementations, the set of candidate models 103 can be selected from a ranking of customized models available on a platform. For example, a pre-determined number of the most popular models can be selected.

In some implementations, the set of candidate models 103 can be obtained (or selected) based upon determining an available customized model's relevance to the user query 101. For example, an embedding of the model's system prompt can be compared to an embedding of the user query 101 using a similarity metric as a measure of the relevance of a customized model to the user query 101. The embedding can be generated using any appropriate embedding neural network for example. The similarity metric can be based upon any appropriate distance measure such as a cosine distance or Euclidean distance. In another example, an LLM-based model can be prompted to determine a ranking of the most relevant models to the user query 101. In a further example, a classifier can be used to determine a relevance score. Meta-data associated with the customized model can also be used to determine relevance, for example, the customized model can be associated with tags or labels that describe the customized model's purpose.

In some implementations, the set of candidate models 103 are obtained (or selected) based upon a measure of diversity of an available set of customized models. For example, a distance metric can be applied to the embeddings of system prompts to ensure that the selected models are at least a threshold distance apart from each other. In another example, the embeddings can be clustered and one model selected from each cluster. Including a diverse set of models in the set of candidate models 103 ensures that a wide range of models and model outputs can be evaluated. In some implementations, a combination of relevance to the user query 101 and diversity of models can be used to obtain/select the set of candidate models 103.

The customized generative machine learning models can be based upon any appropriate generation technique and have any appropriate architecture. For example, the models can be Transformer-based neural network models, be either autoregressive or non-autoregressive, or be based upon diffusion models or generative adversarial networks (GANs). The generative machine learning models can include text-to-image generation for generating output data that comprises image data, e.g. intensity values for each of a plurality of pixels in an image. The generative machine learning models can include text-to-video generation for generating output data that comprises video data, e.g. intensity values for each of a plurality of pixels for each of a plurality of video frames. In both cases, the user query 101 can specify particular objects that are to be depicted in the image/video data and/or particular actions that occur in the image/video data. In some implementations, the data generation process operates in latent/encoding space. The data generation system 100 and/or generative machine learning model(s) can further comprise a decoder configured to convert the latent/encoded representation into an output space such as pixel space or an external decoder can be used.

The generative machine learning models can include text-to-audio generation for generating output data that comprises audio data. The audio data can comprise speech data and/or music data and/or other sounds. The user query 101 can specify the speech content or the sound effects that are to be present in the generated audio. The user query 101 can also specify the generation of music. The generated audio data can comprise a spectrogram representation or raw digital samples of an audio waveform or encoded values for any appropriate audio encoding format. The data generation system 100 and/or generative machine learning model(s) can further comprise a decoder configured to convert the encoded representation into an output audio space or an external decoder can be used.

The generative machine learning models can include generation for other types of data such as computer program code. The user query 101 can specify in natural language a particular functionality of the computer code to be generated and a particular computer programming language for the code for example.

The data generation system 100 can be configured to generate multi-modal output data. As discussed above, the generative machine learning models can also act as a general-purpose AI assistant for carrying out tasks specified by the user through the user query 101. For example, the generative machine learning model can assist a user in writing tasks such as composing emails, provide summaries of documents, emails, and notifications, assist a user in bookings and developing travel itineraries, assist a user with navigation, and generally respond to questions presented by a user.

The data generation system 100 is further configured to prune the set of candidate models 103. In this regard, the data generation system 100 is configured to process the user query 101 using each model of the set of candidate models 103 to generate an intermediate output 104 for each model. For example, each model can process the user query 101 for a pre-determined number of generation steps to generate the intermediate output 104. For example, if the generative machine learning model is an autoregressive model, the intermediate output 104 can be the output tokens that have been generated after the pre-determined number of generation steps. For a diffusion model, the intermediate output 104 can be the output resulting from a pre-determined number of reverse diffusion time steps. Such an intermediate output is likely to be noisy but the early steps of a reverse diffusion process will still typically include coarse structural details can be evaluated. In some implementations, the intermediate output 104 can be considered to be a partial output of the full generation process.

The data generation system 100 can comprise a model execution subsystem 105 that is configured to carry out the processing of the user query 101 using each candidate model. In some implementations, the model execution subsystem 105 is implemented using one or more hardware accelerators such as graphics processing units (GPUs) or tensor processing units (TPUs).

In some implementations, the processing of the user query 101 using each candidate model can be carried out in parallel. For example, where the same underlying generative machine learning model is used, batch processing can be used for processing the user query 101 by some or all of the customized models in parallel. In these implementations, a model input based upon the user query 101 and the system prompt and/or contextual data used to customize the model can be generated, e.g. through concatenation or using an appropriate template. A plurality of the model inputs can be collected to form a batch input, that is, collected together into an input matrix or tensor. The size of the batch input can be determined based upon the hardware used to carry out the processing, for example, based upon the specifications of a graphics processing unit (GPU) or tensor processing unit (TPU). Should the number of model inputs be greater than the batch size, the model inputs can be spread over a plurality of batches.

The batch input can be processed by the underlying generative machine learning model to generate the intermediate outputs 104 for the models corresponding to the batch input. This can be carried out in parallel using suitable matrix/tensor operations. This enables the parameters of the underlying generative machine learning model to be loaded into memory once with batch inputs being swapped in and out memory as appropriate. In addition, common input elements, such as the user query 101 can be processed once by the underlying generative machine learning model and cached to improve computational efficiency.

In implementations where the underlying generative machine learning model is not the same, it is possible instead to load the batch input once into memory and to swap out the model parameters as appropriate.

Processing can also be spread over different processing units using either data or model parallelism schemes.

The data generation system 100 can further comprise a critic machine learning model 106. In some implementations, the critic machine learning model 106 can be external to the data generation system 100 and the data generation system 100 interfaces with the critical machine learning model 106 via an appropriate network connection.

The data generation system 100 is configured to generate a score 107 for each model in the set of candidate models 103 by evaluating the intermediate output 104 using the critic machine learning model 106. In some implementations, the score 107 can be a ranking of the models.

The critic machine learning model 106 can be based upon any appropriate machine learning architecture and can comprise one or more neural network layers. The neural network layers can include any appropriate type of layer such as a feed-forward/MLP-type layer, attention-type layer, Transformer-type layer, recurrent-type layer, LSTM-type layer amongst others.

In some implementations, the critic machine learning model 106 is based upon an LLM (or multi-modal equivalent). In these implementations, an appropriate prompt (or chain of prompts) can be used to cause the critic machine learning model 106 to evaluate the intermediate outputs 104 and to generate a score 107 for each model. In some instances, a general purpose LLM trained on large scale training datasets can be powerful enough to act as the critic machine learning model 106 without further fine-tuning. In other instances, a pre-trained LLM can be fine-tuned to carry out the evaluation task using training techniques such as reinforcement learning with human feedback (RLHF). LLM training and RLHF is described in more detail below. In some implementations, the critic machine learning model 106 can be a distilled version of a larger more powerful general purpose LLM with a distillation objective to replicate the evaluation output of the larger LLM. In some implementations, the critic machine learning model 106 can be trained or updated using online learning which is described in more detail below.

In some implementations, where the underlying generative machine learning model is the same for all candidate models and the model is LLM-based, this underlying model could also be used as the basis for the critic machine learning model 106.

In some implementations, the evaluation carried out by the critic machine learning model 106 can be further based upon user or user device contextual information such as the software application that the data generation process has been launched from, e.g. a chat-based AI assistant, an email client, a word processing application, a web browser, an integrated development environment amongst others. The user context information can also include historical user actions and/or user preferences. For example, historically, a user may send emails to a particular contact using a work email account only. As such, when the user query 101 specifies a task of composing an email to the particular contact, it may be expected that the email is to be a work email and the generated email should have a professional/formal tone.

The data generation system 100 is further configured to prune the set of candidate models 103 based upon the generated scores 107 for each model. For example, the lowest scoring candidate models can be removed. In some implementations, a fixed proportion of the candidate models are removed, e.g. half of the candidate models can be removed. In other implementations, a score threshold can be used with candidate models scoring below the threshold being removed. It will be appreciated that any suitable number of candidate models can be removed as deemed appropriate by a person skilled in the art. The data generation system 100 can comprise a pruning subsystem 108 configured to implement the pruning.

In some implementations, a candidate model can determine that it is not able to generate a response to the user query 101. The intermediate output 104 for the candidate model can comprise an indicator that the model cannot satisfy the user query 101. In response to the detection of such an indicator, the data generation system 100 can be configured to prune the model from the set of candidate models 103.

The data generation system 100 is further configured to continue processing of the user query 101 using the set of remaining candidate models 103 to generate the output data 102 in response to the user query 101. That is, for each of the remaining candidate models, processing of the user query 101 can resume from the point at which it was halted in order for the evaluation and pruning process to take place. Thus, where N generation steps were carried out to generate the intermediate output 104, processing can resume with the N^{th}+1 generation step and starting from the intermediate output 104 as appropriate. For the models that were removed during the pruning process, processing is not continued for these models. However, as described below, in some implementations, their intermediate outputs 104 can be cached in case a removed model is re-selected by a user.

The generation process for each of the remaining candidate models can continue until fully complete or alternatively, further pruning iterations can be carried out on the basis of subsequently generated intermediate outputs. For example, the remaining candidate models can continue generation for another pre-determined number of generation steps. The subsequently generated intermediate output, and if appropriate, in combination with the previously generated intermediate output 104, for each model can be evaluated by the critic machine learning model 106. The lowest scoring models can be removed and processing can continue with a further reduced set of remaining candidate models. Further pruning iterations can be carried out in a similar fashion until one or a desired number of candidate models remain or if the generation process of the remaining candidate models complete before the next pruning iteration.

This repeated pruning can be carried out according to a pruning schedule. For example, the pruning schedule can be based upon a pre-determined number of generation steps to run each model for before the next pruning iteration and can also specify the criteria for removing models. In one example, half of the candidate models are removed every 50 generation steps. The number of generation steps need not be the same for each iteration. For example, the number of generation steps for the first pruning iteration can be larger in order to build up a sufficient amount of intermediate output 104 for evaluation compared to the interval between subsequent pruning iterations. Removing a fixed proportion of models according to a deterministic schedule can provide a calculable worst-case complexity bound. The pruning schedule can be set according to a desired computational efficiency.

If at the end of the generation process, there are multiple candidate models remaining with multiple final outputs generated, the final output of each remaining candidate machine learning model can be evaluated using the critic machine learning model 106 to generate a final score for each candidate model. The highest scoring final output can be provided as the output 102 in response to the user query 101. In some implementations, the output from other candidate models can also be provided as described in more detail below.

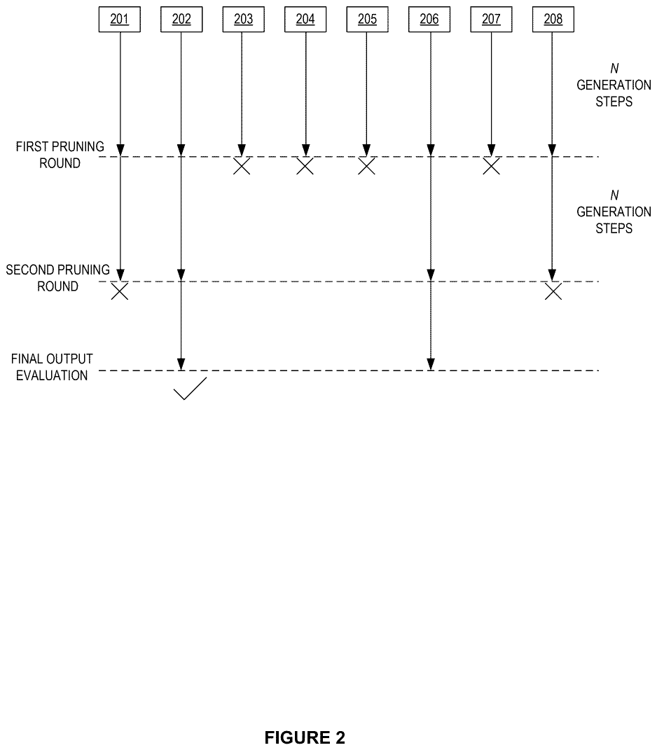

Referring now to FIG. 2, an example illustrating an iterative pruning process is shown. The process can be implemented using the data generation system 100 of FIG. 1. In this example, there is a set of candidate models comprising eight customized generative machine learning models 201 to 208. A pruning schedule of removing half of the candidate models every N generation steps is used. It will be appreciated however that the set of candidate models can comprise any number of customized generative machine learning models and any suitable pruning schedule can be used as deemed appropriate by a person skilled in the art.

In FIG. 2, each candidate model 201 to 208 begins processing of the user query. This processing carries on for N generation steps, at the end of which, processing is halted as per the pruning schedule. The output generated as a result of the N generation steps, i.e. the intermediate output, is evaluated and scored using a critic machine learning model as described above. The lowest scoring 50% of the candidate models are then pruned according to the pruning schedule. In the example of FIG. 2, candidate models 203, 204, 205 and 207 are in the lowest scoring 50% of candidate models and are thus removed. Processing does not continue for any removed candidate models.

The processing of the remaining candidate models 201, 202, 206 and 208 is resumed. The generation process for each of these models can continue on from the intermediate output starting with the N^{th}+1 generation step. This second iteration of processing carries on for another N generation steps according to the pruning schedule, at which point a further round of evaluation and pruning is carried out. The evaluation of each remaining candidate model can be carried out on the basis of all of the output that has been generated so far by each model, i.e. across the 2N generation steps, as appropriate. For example, in an autoregressive model, continuing a generation process can result in further output tokens being appended to previously generated output tokens, providing an expanded output token sequence for evaluation. In other cases, such as a diffusion model, a representation of the output may be continually updated during the generation process and thus the output for evaluation can be an updated version of prior output.

In FIG. 2, candidate models 201 and 208 are determined to be in the lowest scoring 50% of candidate models and are thus removed according to the pruning schedule. Processing does not continue for these two removed candidate models.

The processing of the remaining candidate models 202 and 206 to generate an output in response to the user query continues. In this case, the generation process completes before the next pruning round is scheduled to occur. This provides two alternative final outputs. The final output of each candidate model 202 and 206 is evaluated by the critic machine learning model. The final output of the top scoring candidate model, in this case, candidate model 202, is provided as the output in response to the user query.

As noted above, in some implementations, the critic machine learning model can be trained using online learning, that is, the critic machine learning model can be trained from user feedback whilst the system is in use on a user device. For example, the user can be presented with a feedback interface such as a “thumbs-up” icon for the user to indicate their approval of the provided output response and a “thumbs-down” icon for the user to indicate their disapproval of the provided output response. If the user selects the “thumbs-up” icon, this can provide a positive learning signal. For example, this can translate to a positive reward if reinforcement learning is used.

If the user selects the “thumbs-down” icon and disapproves of the provided output response, the system can present one or more of the alternative final outputs generated by the other candidate models. In the example of FIG. 2, the final output generated by candidate model 206 can be presented to the user. If there are no other alternatives or if the user also disapproves of the presented alternatives, the intermediate outputs of removed candidate models can be presented to the user. For example, in the example of FIG. 2, the intermediate outputs of candidate models 203, 204, 205 and 207 pruned at the second pruning iteration can be presented to the user. If the user selects one of these pruned alternatives, the system can resume processing of the selected candidate model from its last performed generation step and its intermediate output. In some implementations, intermediate outputs of pruned models can be cached in case of resumption initiated by the user.

The user selection of any alternative to the initially provided response to the user query can provide a training signal for updating the parameters of the critic machine learning model. For example, this can translate to a negative reward associated with the initially provided response and a positive reward for the alternative response if reinforcement learning is used.

Additionally, or alternatively, the pruning process can be run interactively to obtain user feedback for training the critic machine learning model. For example, at one or more pruning iterations, the user can be presented with a ranking of each of the intermediate outputs of the candidate models. The user can then re-rank the intermediate outputs thereby providing a target ranking for use in updating the parameters of the critic machine learning model.

Alternatively, the user can be presented with the intermediate outputs of one or more candidate models that are intended to be maintained in the candidate set and/or intended to be removed from the candidate set. If the user chooses to keep a model that is intended to be removed, or choose to remove a model that is intended to be kept, this can also provide a training target for use in updating the parameters of the critic machine learning model.

The subsequent continuation of the pruning process can take account of any user interventions. For example, the user's re-ranking can be used to determine which models to prune or if a user chooses alternative models to save or prune, such a choice should be respected by the system. Thus, pruning of the set of candidate models can be based upon user feedback obtained on the generated intermediate outputs. It will be appreciated that above described methods of obtaining user feedback and presenting alternatives to the user are exemplary and are not intended to be limiting. Any appropriate method of obtaining user feedback and presenting alternatives can be used as deemed appropriate by a person skilled in the art.

The parameters of the critic machining learning model can be updated based upon the user feedback using any appropriate training technique. For example, training based upon reinforcement learning with human feedback (RLHF) can be used. RLHF is described in more detail below. Alternatively, training based upon Direct Preference Optimization (DPO) or similar techniques can be used. In DPO, a model can be trained directly on user preference data without needing to train a reward model as in RLHF. Further details regarding DPO can be found in Rafailov, Rafael, et al. “Direct preference optimization: Your language model is secretly a reward model,” Advances in Neural Information Processing Systems 36(2024), which is hereby incorporated by reference in its entirety.

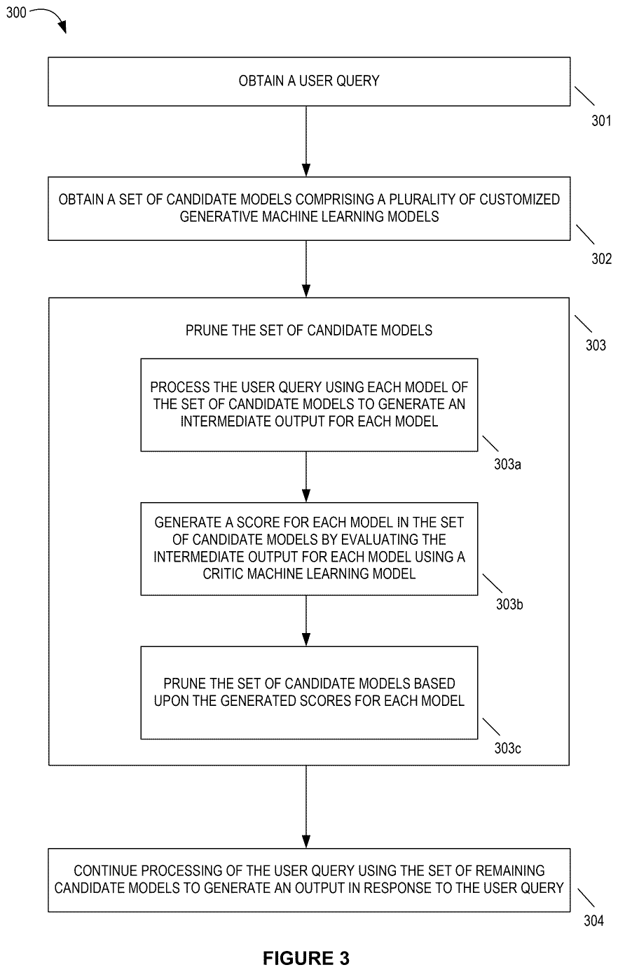

FIG. 3 is a flow diagram illustrating an example method 300 for generating output in response to a user query. The processing shown in FIG. 3 can be implemented using the data generation system of FIG. 1. As such, features described in the context of FIG. 1 can also be applied to the method of FIG. 3.

At step 301, a user query is obtained. As described above, the user query can comprise instructions for generating data or specify a particular task a data generation system is to perform. The user query can comprise text in natural language instructing the generation of a particular modality (or modalities) of data and describing the data to be generated. In some implementations, the user query can comprise additional data such as image, video and/or audio data that the generation is to be conditioned on.

At step 302, a set of candidate models is obtained. The set of candidate models comprises a plurality of customized generative machine learning models. As described above, in some implementations, the plurality of customized generative machine learning models utilize the same underlying generative machine learning model and are customized using different system prompts and/or contextual data. A system prompt can comprise one or more instructions for generating output by the generative machine learning model. In some implementations, the contextual data can comprise data retrieved from one or more external data sources. For example, the contextual data can be retrieved based upon a retrieval augmented generation technique as described above.

In some implementations, at least two of the customized generative machine learning models are different. That is, the models can have different parameter values and/or architectures. The customized generative machine learning models can be based upon any appropriate generation technique and have any appropriate architecture. For example, the models can be Transformer-based neural network models, be either autoregressive or non-autoregressive, or be based upon diffusion models or generative adversarial networks (GANs). As described above, the generative machine learning models can include text-to-image generation, text-to-audio generation, text-to-video generation and/or general purpose text generation. In some implementations, the generation process can be conditioned on additional data of any modality.

As described above, in some implementations, the set of candidate models can be obtained based upon determining an available customized model's relevance to the user query. In addition, or alternatively, the set of candidate models can be obtained based upon a measure of diversity of an available set of customized models.

At step 303, the set of candidate models is pruned. Step 303 comprises steps 303a to 303c.

At step 303a, the user query is processed using each model of the set of candidate models to generate an intermediate output for each model. In some implementations, the user query is processed for a pre-determined number of generation steps by each model to generate the intermediate output. As described above, if the generative machine learning model is an autoregressive model, the intermediate output can be the output tokens that have been generated after the pre-determined number of generation steps. For a diffusion model, the intermediate output can be the output resulting from a pre-determined number of reverse diffusion time steps. The intermediate output can be a partial output of the full generation process.

In some implementations, batch processing can be used to generate the intermediate output for models in parallel where the plurality of customized generative machine learning models utilize the same underlying generative machine learning model. For example, as described above, a model input can be generated for each model based upon the user query and the system prompt and/or contextual data used to customize the model. A plurality of respective model inputs can be collected to form a batch input and the batch input can be processed using the same underlying generative machine learning model to generate the intermediate output for the models corresponding to the plurality of respective model inputs. The batch input can be processed by the underlying generative machine learning model to generate the intermediate outputs for the models corresponding to the batch input. This can be carried out in parallel using suitable matrix/tensor operations and using either data or model parallelism where appropriate. In some implementations, the processing is implemented using a hardware accelerator such as one or more graphics processing units (GPUs) or tensor processing units (TPUs).

At step 303b, a score for each model in the set of candidate models is generated by evaluating the intermediate output for each model using a critic machine learning model. The score can be a ranking. As described above, the critic machine learning model can be based upon any appropriate machine learning architecture and can comprise one or more neural network layers. In some implementations, the critic machine learning model can be based upon an LLM. In some implementations, the critic machine learning model can be based upon the same underlying generative machine learning model of the plurality of customized generative machine learning models. In some implementations, the evaluation carried out by the critic machine learning model can be further based upon user or user device contextual information as described above.

At step 303c, the set of candidate models is pruned based upon the generated scores for each model. In some implementations, a fixed proportion of the worst scoring candidate models are removed. In some implementations, up to and including half of the models in the set of candidate models are removed.

At step 304, the processing of the user query is continued using the set of remaining candidate models to generate an output in response to the user query. In some implementations, the set of remaining candidate models are repeatedly pruned based upon subsequent intermediate outputs generated from the continued processing of the user query by the remaining candidate models. That is, the remaining candidate models can continue processing the user query to generate subsequent intermediate output similar to step 303a. A score for each remaining model can be generated by evaluating the subsequent intermediate output and if appropriate, in combination with the previously generated intermediate output similar to step 303b. The remaining candidate models can be pruned based upon these new scores similar to step 303c to provide a further reduced set of remaining candidate models. This can be repeated until a desired stopping criterion is reached, such as one or a desired number of candidate models remain, or a final output is generated by each remaining candidate model prior to the start of a next pruning round. The repeated pruning can be carried out according to a pruning schedule. For example, as described above, the pruning schedule can be based upon a pre-determined number of generation steps to run each model for before the next pruning iteration and can also specify the criteria for removing models.

In some implementations, the intermediate output (or subsequent intermediate output) for a model comprises an indicator that the model cannot satisfy the user query. In response to detecting the indicator, the model can be pruned from the (current) set of candidate models.

Where multiple candidate models have generated final outputs, the final output generated by each candidate model can be evaluated using the critic machine learning model to generate a final score for each candidate model. The highest scoring final output can be provided in response to the user query. In some implementations, alternative final outputs and/or intermediate outputs of removed candidate models can also be provided to the user as possible alternatives for selection as described above.

In some implementations, the pruning process can be an interactive process and pruning the set of candidate models can be based upon user feedback obtained on the generated intermediate outputs (or subsequent intermediate outputs) as described above.

In some implementations, the critic machine learning model is updated based upon the user feedback. For example, the final output of one or more other candidate models can be provided to the user in addition to the highest scoring final output. An indication that a user selected a non-highest scoring final output can be received and the critic machine learning model can be updated based upon the non-highest scoring final output/candidate model selected by the user.

In some implementations, the intermediate output of a pruned candidate model (that is, a removed candidate model) can be additionally provided. An indication that a user selected the intermediate output of the pruned candidate model can be received. The processing of the user query using the selected pruned candidate model can be resumed from its intermediate output in order to generate a response to the user query. The critic machine learning model can be updated based upon the pruned candidate model selected by the user. For example, the intermediate output and/or the final output generated by the selected pruned candidate model can be used to update the critic machine learning model.

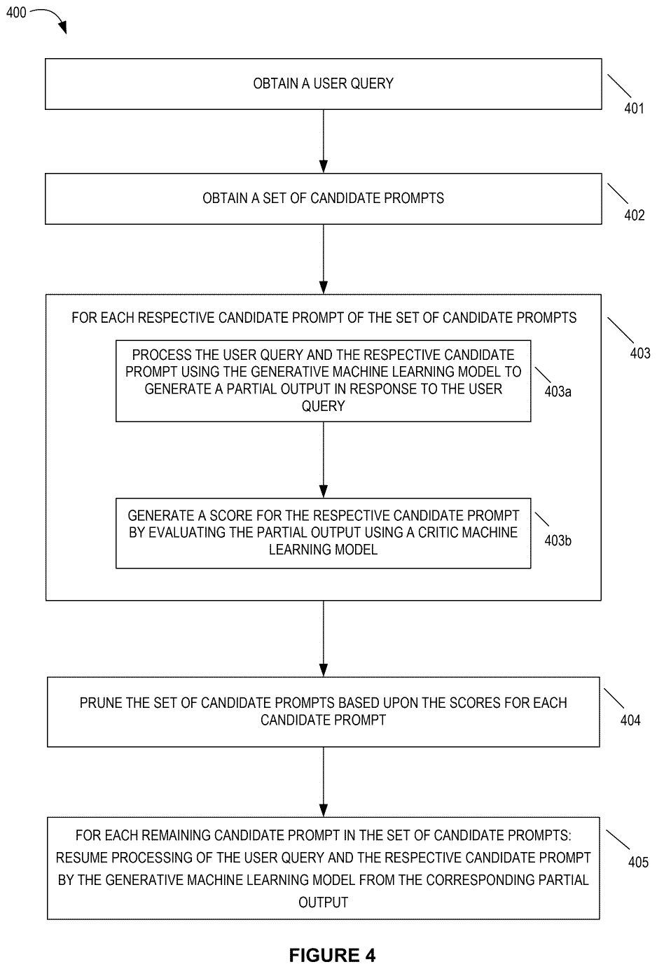

FIG. 4 is a flow diagram illustrating an example method 400 for generating output in response to a user query. The processing shown in FIG. 4 can be implemented using the data generation system of FIG. 1. As such, features described in the context of FIG. 1 can also be applied to the method of FIG. 4.

At step 401, a user query is obtained as per step 301 of FIG. 3.

At step 402, a set of candidate prompts is obtained. Each candidate prompt comprises a different set of instructions for generating output by a generative machine learning model in response to user queries. That is, each candidate prompt can be a system prompt for customizing a generative machine learning model as described above.

Step 403 comprises steps 403a and 403b and is carried out for each respective candidate prompt of the set of candidate prompts. In more detail, at step 403a, the user query and the respective candidate prompt are processed using the generative machine learning model to generate a partial output in response to the user query. That is, the same generative machine learning model is used for each candidate prompt. In some implementations, the processing can be carried out in parallel using batch processing as described above.

At step 403b, a score is generated for the respective candidate prompt by evaluating the partial output using a critic machine learning model. This can be carried out as described above.

At step 404, the set of candidate prompts is pruned based upon the scores for each candidate prompt as per step 303c of FIG. 3.

At step 405, for each remaining candidate prompt in the set of candidate prompts, the processing of the user query and the respective candidate prompt by the generative machine learning model can be resumed from the corresponding partial output. As discussed above, further pruning iterations can also be carried out according to a pruning schedule. A final output in response to the user query can be provided as described above.

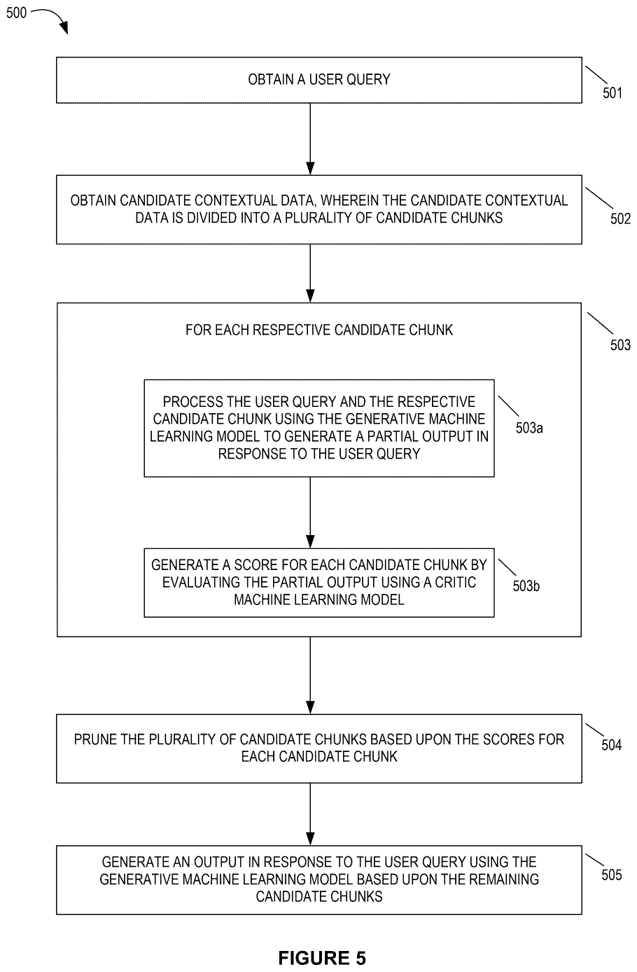

FIG. 5 is a flow diagram illustrating an example method 500 for generating output in response to a user query. The processing shown in FIG. 5 can be carried out using the data generation system of FIG. 1. As such, features described in the context of FIG. 1 can also be applied to the method of FIG. 5.

At step 501, a user query is obtained as per step 301 of FIG. 3.

At step 502, candidate contextual data is obtained. The candidate contextual data is divided into a plurality of candidate chunks. The candidate contextual data is obtained from one or more data sources based upon the user query. In some implementations, the candidate contextual data is obtained using a retrieval augmented generation technique as described above. A candidate chunk can be an individual chunk and/or a combination of chunks.

Step 503 comprises steps 503a and 503b and is carried out for each respective candidate chunk. In more detail, at step 503a, the user query and the respective candidate chunk are processed using the generative machine learning model to generate a partial output in response the user query. That is, the same generative machine learning model is used for each candidate chunk. In some implementations, the processing can be carried out in parallel using batch processing as described above.

At step 503b, a score is generated for the respective candidate chunk by evaluating the partial output using a critic machine learning model. This can be carried out as described above.

At step 504, the plurality of candidate chunks are pruned based upon the scores for each candidate chunk. This can also be carried out as described above.

At step 505, an output in response to the user query using the generative machine learning model can be generated in response to the user query based upon the remaining candidate chunks. As described above, this can comprise continuing the processing of the user query and the remaining candidate chunks using the generative machine learning model from the corresponding partial output. As discussed above, further pruning iterations can also be carried out according to a pruning schedule. A final output in response to the user query can be provided as described above.

In some prior art RAG-based techniques, all retrieved contextual data is provided as input the generative machine learning model requiring a large context window size. Instead, the processing of FIG. 5 can be used to evaluate individual chunks or combinations of chunks for their suitability for responding to a user query. Irrelevant candidate chunks can be identified quickly and removed. Generation of the response to user query can be based upon the most relevant candidate chunk which can have a much smaller context window size and thus requiring significantly fewer computational resources. In some implementations, the processing of FIG. 5 can used to determine the most relevant candidate chunks quickly. The identified candidate chunks can then be combined and provided as input to the generative machine learning model to generate the response to user query rather than continuing generation on the basis of the candidate chunks independently.

It will be appreciated that the processes of FIGS. 3 to 5 can be combined in any appropriate manner.

Generation of data using diffusion neural networks (also known as denoising neural networks) will now be described in more detail. Examples of diffusion models include DDIM (Denoising Diffusion Implicit Models) and DDPM (Denoising Diffusion Probabilistic Models). In general, diffusion models generate data by using a noise removal process which is also known as a reverse diffusion process. To perform a reverse diffusion process, the system can utilize a conditioning input, for example, a user prompt discussed above.

The system can initialize a representation of a new data item by sampling noise values from a noise distribution. The system can then update the representation of the new data item at each of a plurality of reverse diffusion steps. As part of the updating, at each reverse diffusion step, the system processes a denoising input for the reverse diffusion step that includes the representation of the new data item using the diffusion neural network conditioned on the conditioning input to generate a denoising output that defines an estimate of a noise component of the representation of the new data item.

Optionally, the system can use classifier-free guidance at each reverse diffusion step. When using classifier-free guidance, the system processes another denoising input for the reverse diffusion step that includes the representation of the new data item using the denoising neural network but not conditioned on the conditioning input to generate another denoising output. The system then combines the conditional and unconditional denoising outputs in accordance with a guidance weight for the reverse diffusion step to generate a final denoising output.

At each reverse diffusion step, the system then updates the representation of the new data item using the denoising output. For example, the system can determine an estimate of the data item using the denoising output and then apply an appropriate diffusion sampler, e.g., the DDPM sampler, the DDIM sampler or another appropriate sampler, to the estimate to update the current representation. At the last reverse diffusion step, the system can use the estimate as the updated representation.

After updating the representation of the new data item at each of the plurality of reverse diffusion steps, the system generates the new data item from the representation of the new data item. Each denoising output can define an estimate of a noise component of the corresponding representation of the corresponding data item. The denoising output can define this estimate in any of a variety of ways.

In some implementations, the denoising output is an estimate of the noise component of the current representation, i.e., the noise that needs to be combined with, e.g., added to or subtracted to, a final representation to generate the current representation.

In some other implementations, the denoising output is an estimate of the final representation given the current representation, i.e., an estimate of the representation that would result from removing the noise component of the current representation.

In some other implementations, the denoising output defines a predicted residual between the true noise component of the current representation and an analytic estimate of the noise component, i.e., an estimate that has been computed analytically from the current representation.

In some other implementations, the denoising output is a v-parametrization of the estimate of the noise component.

In any of the above examples, the representations of the data item received as input by the diffusion neural network and updated using the diffusion neural network can either be representations in the output space, e. g, so that the values in the representation are values of image pixels, or an output data item in a latent space, e.g., so that the values in the representation are values in a latent representation of an image in the output space.

When the representations are in a latent space, the system can generate the data item in output space by processing the final representation in the latent space using a decoder neural network, e.g., one that has been pre-trained in an auto-encoder framework with an encoder neural network. During training, the system can use an encoder neural network, e.g., one that has been pre-trained jointly with the decoder in the auto-encoder framework, to encode target data items in the output space to generate target representations for the diffusion neural network in the latent space.

The diffusion neural network can be any appropriate diffusion neural network that is configured to receive an input that includes a current (noisy) representation of a data item and a conditioning input and to generate a denoising output.

In some implementations, the diffusion neural network performs a diffusion process in output space, e.g., pixel space when the data items are images. In this example, when the data items are images, the data items (“representations”) operated on and generated by the diffusion neural network have values for each pixel that specify color values, e.g., RGB values or another color encoding scheme.

Examples of such diffusion neural networks include Imagen, further details of which can be found in S. Chitwan, et al. “Photorealistic text-to-image diffusion models with deep language understanding.” Advances in neural information processing systems 35 (2022): 36479-36494 which is hereby incorporated by reference in its entirety.

In some other implementations, the diffusion neural network performs a diffusion process in latent space, e.g., in a latent space that is lower-dimensional than the output space. That is, the data items (“representations”) operated on by the diffusion neural network are latent representations and the values in the representations are learned, latent values, e.g., rather than color values when the data items are images.

Examples of such diffusion neural networks include Stable Diffusion, further details of which can found in R. Rombach, et al., “High-Resolution Image Synthesis with Latent Diffusion Models,” arXiv: 2112.10752 (2021), which is hereby incorporated by reference in its entirety.

In these implementations, during training, the diffusion neural network can be associated with an encoder to encode training data items into the latent space and, after training and to generate new output data items, a decoder neural network that receives an input that includes a latent representation of a data item and decodes the latent representation to reconstruct the data item.

In general, diffusion neural networks can be trained using a training dataset of the type of data to be generated, e.g. an image dataset, a video dataset, an audio dataset etc. Image and video data can be captured by an image sensor of a digital camera, LIDAR, infra-red camera or any other camera type. Audio data can be captured from an audio transducer such as a microphone.

The diffusion neural network can be trained over a plurality of training iterations. In each training iteration, one or more training data items can be sampled from the training dataset. A timestep can be sampled, e.g. from a uniform probability distribution, for each of the one or more training data items. Noise can be sampled, e.g. from a Gaussian distribution, to be used in a forward diffusion process that adds noise to the training data item up to the sampled timestep. The diffusion neural network attempts to predict the added noise based upon the noisy image and the timestep. The parameters of the diffusion neural network can be updated using an objective function based upon a comparison between the predicted noise and the sampled noise.

Further details regarding LLMs will now be described. An LLM can be an auto-regressive neural network that generates each token in an output sequence conditioned on the preceding tokens in the output sequence and at least some of the tokens in an input sequence.

For example, the LLM can be configured to process an input sequence of tokens from a vocabulary of tokens to generate an output sequence of tokens from the vocabulary.

More generally, an LLM generative machine learning model can be any appropriate neural network that receives an input sequence made up of tokens selected from a vocabulary and auto-regressively generates an output sequence made up of tokens from the vocabulary. For example, the generative machine learning model can be a Transformer-based neural network or a recurrent neural network-based neural network.

In some situations, the generative machine learning model can be referred to as an auto-regressive neural network when the neural network used to implement the neural network auto-regressively generates an output sequence of tokens. More specifically, the auto-regressively generated output is created by generating each particular token in the output sequence conditioned on a current input sequence that includes any tokens that precede the particular text token in the output sequence, i.e., the tokens that have already been generated for any previous positions in the output sequence that precede the particular position of the particular token, and a context input that provides context for the output sequence.

For example, the current input sequence when generating a token at any given position in the output sequence can include the input sequence and the tokens at any preceding positions that precede the given position in the output sequence. As a particular example, the current input sequence can include the input sequence followed by the tokens at any preceding positions that precede the given position in the output sequence. Optionally, the input and the current output sequence can be separated by one or more predetermined tokens within the current input sequence.

More specifically, to generate a particular token at a particular position within an output sequence, the generative machine learning model can process the current input sequence to generate a score distribution (e.g., a probability distribution) that assigns a respective score, e.g., a respective probability, to each token in the vocabulary of tokens. The generative machine learning model can then select, as the particular token, a token from the vocabulary using the score distribution. For example, the generative machine learning model can greedily select the highest-scoring token or can sample, e.g., using nucleus sampling or another sampling technique, a token from the distribution.

As a particular example, the generative machine learning model can be an auto-regressive Transformer-based neural network that includes (i) a plurality of attention blocks, at least some of which apply a self-attention operation and (ii) an output subnetwork that processes an output of the last attention block to generate the score distribution.

The generative machine learning model can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv: 2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv: 2005.14165, 2020. All of which are hereby incorporated by reference in their entirety.

The generative machine learning model can undergo a first phase of pre-training followed by a second phase of fine-tuning. In general, a generative machine learning model such as an LLM can be pre-trained on large amounts of data including data from, but not limited to, webpages, electronic books, software code, electronic news articles, and machine translation data. The generative machine learning model can be pre-trained using unsupervised or self-supervised learning. For example, the generative machine learning model can be pre-trained on a next token prediction task and/or a masked token prediction task. Pre-training on large quantities of diverse data can provide the generative machine learning model with remarkable natural language reasoning capabilities.

Following pre-training, the generative machine learning model can undergo fine-tuning to improve the model's ability to respond to user prompts and queries. Two example types of fine-tuning techniques are supervised fine-tuning (SFT) and reinforcement learning with human feedback (RLHF).

In SFT, a high-quality dataset including examples of input prompts and corresponding responses can be used. This data is typically generated by human annotators. The generative machine learning model can be trained using supervised learning to generate the corresponding responses from the input prompt. SFT requires a much smaller amount of data that used in pre-training.

In RLHF, a reward model can be trained from human preference data regarding different outputs generated from the same input prompt. That is, given an input prompt, different outputs are generated using different models. The models can be a copy of the generative machine learning model with different parameters obtained through checkpointing during pre-training or the models could be entirely unrelated. The input prompt and the different outputs are shown to human assessors and the human assessors are asked to rank the outputs in order of preference with respect to the input prompt. This can be repeated with many different input prompts to generate a dataset of preference data. A reward model can be trained on this preference data to provide a scalar preference value (a “reward” value) for a particular input prompt and generated output pair. The reward model can be based on the generative machine learning model with an additional head for generating the scalar value for example.

The generative machine learning model undergoing training can then be fine-tuned using reinforcement learning based upon the reward values provided by the trained reward model. That is, for a given training prompt, the generative machine learning model generates an output which can be evaluated using the reward model. The parameters of the generative machine learning model can be adjusted using a reinforcement learning update rule based upon the reward value provided by the reward model. In some implementations, a reinforcement learning update rule based upon the Proximal Policy Optimization (PPO) algorithm is used with the generative machine learning model acting as the “policy”.

Through such training, it is possible that a generative machine learning model can respond to user queries and instructions in a zero-shot manner, for example, by including appropriate instructions and examples in the prompt provided to the generative machine learning model without the need for further extensive fine-tuning.

It will be appreciated that the above also applies for any autoregressive neural network that is used in the data generation process. An example of an autoregressive neural network for audio generation is AudioLM, further details of which can found in Z. Borsos, et al. “Audiolm: a language modeling approach to audio generation.” IEEE/ACM transactions on audio, speech, and language processing 31 (2023): 2523-2533 which is hereby incorporated by reference in its entirety.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

As used herein, the term data processing apparatus includes any suitable computing device or hardware for use in performing the methods described in this specification. The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The essential elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. In some cases, multitasking and parallel processing may be advantageous.

What is claimed is:

1. A method implemented by one or more data processing apparatus, the method comprising:
obtaining a user query;
obtaining a set of candidate models comprising a plurality of customized generative machine learning models;
pruning the set of candidate models, wherein pruning comprises:
processing the user query using each model of the set of candidate models to generate an intermediate output for each model;
generating a score for each model in the set of candidate models by evaluating the intermediate output for each model using a critic machine learning model; and
pruning the set of candidate models based upon the generated scores for each model; and
continuing processing of the user query using the set of remaining candidate models to generate an output in response to the user query.

2. The method of claim 1, wherein the plurality of customized generative machine learning models utilize the same underlying generative machine learning model and are customized using different system prompts and/or contextual data.

3. The method of claim 2, wherein each system prompt comprises one or more instructions for generating output by the generative machine learning model.

4. The method of claim 2, wherein the contextual data comprises data retrieved from one or more external data sources.

5. The method of claim 4, wherein the contextual data is retrieved based upon a retrieval augmented generation technique.

6. The method of claim 2, wherein processing the user query using each model of the set of candidate models to generate an intermediate output for each model comprises:
generating, for each model, a model input based upon the user query and the system prompt and/or contextual data used to customize the model;
collecting a plurality of respective model inputs to form a batch input; and
processing the batch input using the same underlying generative machine learning model to generate the intermediate output for the models corresponding to the collected plurality of respective model inputs.

7. The method of claim 1, wherein processing the user query using each model of the set of candidate models to generate an intermediate output for each model comprises:
processing the user query using each model for a pre-determined number of generation steps to generate the intermediate output.

8. The method of claim 1, wherein pruning the set of candidate models based upon the generated scores for each model comprises removing up to and including half of the models in the set of candidate models.

9. The method of claim 1, wherein continuing processing of the user query using the set of remaining candidate models to generate an output in response to the user query comprises:
repeatedly pruning the set of remaining candidate models based upon subsequent intermediate outputs generated from the continued processing of the user query by the remaining candidate models.

10. The method of claim 9, wherein the repeated pruning is carried out according to a pruning schedule.

11. The method of claim 1, wherein the intermediate output for a model comprises an indicator that the model cannot satisfy the user query; and
in response to detecting the indicator, pruning the model from the set of candidate models.

12. The method of claim 1, wherein pruning the set of candidate models is further based upon user feedback obtained on the generated intermediate outputs.

13. The method of claim 12, wherein the method further comprises updating the critic machine learning model based upon the user feedback.

14. The method of claim 1, wherein generating an output in response to the user query comprises:
obtaining a final output from each candidate model in the set of remaining candidate models;
evaluating the final output using the critic machine learning model to generate a final score for each candidate model; and
providing as the output in response to the user query, at least the highest scoring final output.

15. The method of claim 14, wherein the method further comprises:
additionally providing the final output of one or more other candidate models;
receiving an indication that a user selected a non-highest scoring final output; and
updating the critic machine learning model based upon the non-highest scoring final output selected by the user.

16. The method of claim 14, wherein the method further comprises:
additionally providing the intermediate output of a pruned candidate model;
receiving an indication that a user selected the intermediate output of the pruned candidate model;
resuming processing of the user query using the pruned candidate model from its intermediate output to generate a response to the user query; and
updating the critic machine learning model based upon the pruned candidate model selected by the user.

17. The method of claim 1, wherein the set of candidate models are obtained based upon determining an available customized model's relevance to the user query.

18. The method of claim 1, wherein the set of candidate models are obtained based upon a measure of diversity of an available set of customized models.

19. A system comprising:
one or more data processing apparatus; and
a memory storing instructions that when executed by the one or more data processing apparatus cause the one or more data processing apparatus to carry out a method comprising:
obtaining a user query;
obtaining a set of candidate prompts, wherein each candidate prompt comprises a different set of instructions for generating output by a generative machine learning model in response to user queries;
for each respective candidate prompt of the set of candidate prompts:
processing the user query and the respective candidate prompt using the generative machine learning model to generate a partial output in response to the user query; and
generating a score for the respective candidate prompt by evaluating the partial output using a critic machine learning model;
pruning the set of candidate prompts based upon the scores for each candidate prompt; and
for each remaining candidate prompt in the set of candidate prompts:
resuming processing of the user query and the respective candidate prompt by the generative machine learning model from the corresponding partial output.

20. A non-transitory computer-readable storage medium comprising instructions that when executed by one or more data processing apparatus cause the one or more data processing apparatus to carry out a method comprising:
obtaining a user query;
obtaining candidate contextual data, wherein the candidate contextual data is divided into a plurality of candidate chunks, and wherein the candidate contextual data is obtained from one or more data sources based upon the user query;
for each respective candidate chunk:
processing the user query and the respective candidate chunk using the generative machine learning model to generate a partial output in response to the user query; and
generating a score for each candidate chunk by evaluating the partial output using a critic machine learning model;
pruning the plurality of candidate chunks based upon the scores for each candidate chunk; and
generating an output in response to the user query using the generative machine learning model based upon the remaining candidate chunks.
